(19) United States
(12) Patent Application Publication
(10) Pub. No.: US 2026/0015944 A1
(43) Pub. Date: Jan. 15, 2026

(54) TURBINE ENGINE SCROLL FOR USE WITH AN INTERNAL COMBUSTION ENGINE

(71) Applicant: Pratt & Whitney Canada Corp., Longueuil (CA)

(72) Inventor: Remo Marini, Lasalle (CA)

(21) Appl. No.: 19/335,977

(22) Filed: Sep. 22, 2025

Related U.S. Application Data
(63) Continuation-in-part of application No. 18/129,616, filed on Mar. 31, 2023, now Pat. No. 12,442,310.

(51) Int. Cl. F01D 9/02; F01D 9/04

(52) U.S. Cl. CPC F01D 9/026; F01D 9/041; F01D 9/048; F05D 2220/40; F05D 2240/12; F05D 2240/14

(57) ABSTRACT

An assembly is provided comprising a turbine scroll and a turbine stator vane assembly. The turbine scroll includes a flowpath, a flow channel, scroll stator vanes, and an annular collection region. The flowpath extends along the scroll from an inlet to an outlet. The flow channel defines an outer radial wall extending between axial sidewalls spaced widthwise. The flow channel extends circumferentially around a center axis to a terminal end. The scroll stator vanes are distributed circumferentially about the center axis and disposed within the flow channel. The annular collection region is disposed radially inward of the flow channel and extends circumferentially about and axially along the center axis. The annular collection region is configured to receive gas flow from the flow channel. The turbine stator vane assembly is disposed at the outlet and includes a plurality of turbine stator vanes distributed circumferentially about the center axis.

### CROSS-REFERENCE TO RELATED APPLICATIONS

This application is a continuation-in-part of U.S. application Ser. No. 18/129,616 filed Mar. 31, 2023, which is hereby incorporated by reference in its entirety.

### BACKGROUND OF THE INVENTION

### 1. Technical Field

The present disclosure relates rotary engines in general and to turbine scrolls for use with internal combustion engines in particular.

### 2. Background Information

A rotary internal combustion engine (“rotary engine”) sometimes referred to as a Wankel engine typically include a plurality of similar axially aligned rotary units driving a common eccentric shaft. Each rotary unit includes an exhaust port for collecting combustion gases produced in the respective rotary unit. In some instances, the rotary engine may be paired with a scroll that organizes engine combustion gases for entry into a turbine. The turbine may be connected to compressor that draws in air and provides it to the rotary engine for use in combustion.

Each rotary unit of the rotary engine operates in a cyclic manner, periodically producing combustion gases. The collective flow of combustion gases from the rotary engine, therefore, includes a periodic portion that may be referred to as “pulsation portion”. The combustion gases exiting a conventional scroll (i.e., entering the turbine inlet) typically have circumferential and radial flow nonuniformities as a function of time. In other words, the aforesaid non-uniformities may be spatially disposed (e.g., circumferentially, radially) and variable as a function of time. This non-uniform gas flow entering the turbine very often decreases the turbine (isentropic) efficiency and subjects the turbine to periodic excitation forces that over time can cause structural effects; e.g., fatigue.

### SUMMARY

According to an aspect of the present disclosure, a turbine scroll assembly for use with an axial turbine is provided. The assembly includes a turbine scroll and a turbine stator vane assembly. The turbine scroll comprises a flowpath, a flow channel, a plurality of scroll stator vanes and an annular collection region. The flowpath may extend along the turbine scroll from a scroll inlet to a scroll outlet. The flow channel may be defined by an outer radial wall extending between a first axial sidewall and a second axial sidewall. The first axial sidewall and second axial sidewall may be spaced widthwise apart from one another. The flow channel may extend circumferentially around a center axis to a terminal end. The plurality of scroll stator vanes may be distributed circumferentially about the center axis and disposed within the flow channel. The annular collection region may be disposed radially inward of the flow channel, and may extend circumferentially about and axially along the center axis. The annular collection region may be configured to receive gas flow from the flow channel. The turbine stator vane assembly may be disposed proximate the scroll outlet and may include a plurality of turbine stator vanes distributed circumferentially about the center axis.

According to any of the aspects and/or embodiments described above and herein, the turbine scroll further comprises a plurality of vane passages. Each of the plurality of vane passages may be defined between adjacent scroll stator vanes of the plurality of scroll stator vanes. Each of the plurality of vane passages may be open to an outer flow channel portion of the flow channel and extend to the terminal end of the flow channel. The outer flow channel portion may be disposed radially between the plurality of scroll stator vanes and the outer radial wall. Each of the plurality of vane passages may be configured to direct gas flow to the annular collection region.

According to any of the aspects and/or embodiments described above and herein, the annular collection region may be arranged along the flowpath between the plurality of scroll stator vanes and the turbine stator vane assembly. The annular collection region may extend axially between the terminal end of the flow channel and the scroll outlet.

According to any of the aspects and/or embodiments described above and herein, the turbine stator vane assembly may include an inner radial hub and an outer radial hub. The inner radial hub and/or the outer radial hub may extend axially along the center axis. The plurality of turbine stator vanes may extend spanwise between and may be connected to the inner radial hub and the outer radial hub. The inner radial hub may form an inner peripheral boundary of the flowpath and the outer radial hub may form an outer peripheral boundary of the flowpath.

According to any of the aspects and/or embodiments described above and herein, the plurality of turbine stator vanes may include a first turbine stator vane. A first neighboring turbine stator vane may be circumferentially offset from the first turbine stator vane by a first offset distance. A second neighboring turbine stator vane may be circumferentially offset from the first turbine stator vane by a second offset distance. The first offset distance may be different than the second offset distance.

According to any of the aspects and/or embodiments described above and herein, the first neighboring turbine stator vane may be angularly offset from the first turbine stator vane by a first offset angle. The second neighboring turbine stator vane may be angularly offset from the first turbine stator vane by a second offset angle. The first offset angle may be different than the second offset angle. The first neighboring turbine stator vane may be angularly offset from the first turbine stator vane in a clockwise direction. The second neighboring turbine stator vane may be angularly offset from the first turbine stator vane in the clockwise direction or a counterclockwise direction.

According to any of the aspects and/or embodiments described above and herein, each of the plurality of scroll stator vanes may be configured with a hollow interior. A tube may extend within the hollow interior to an exterior region of the scroll.

According to any of the aspects and/or embodiments described above and herein, the outer radial wall includes a flow diverter.

According to any of the aspects and/or embodiments described above and herein, each of the plurality of scroll stator vanes may extend widthwise between the first axial sidewall and the second axial sidewall. Each of the plurality of scroll stator vanes may be connected to the first axial sidewall and the second axial sidewall.

According to any of the aspects and/or embodiments described above and herein, the outer radial wall of the flow channel may be non-axisymmetric about the center axis. The outer radial wall may spiral radially inwardly around a circumference of the scroll. The flow channel portion may include a cross-sectional area that decreases circumferentially.

According to any of the aspects and/or embodiments described above and herein, the plurality of scroll stator vanes include a first scroll stator vane and a second scroll stator vane. The first scroll stator vane may be spaced from the outer radial wall by a first radial distance, the second scroll stator vane may be arranged within the flowpath downstream of the first scroll stator vane, and spaced from the outer radial wall by a second radial distance. The second radial distance may be less than the first radial distance.

According to an aspect of the present disclosure, an assembly is provided including a turbine scroll and a turbine stator vane assembly. The turbine scroll comprises a flowpath, an outer flow channel, a plurality of scroll stator vanes, a vane passage and an annular collection region. The flowpath may extend between a scroll inlet and a scroll outlet. The outer flow channel may extend circumferentially about and radially along a center axis. The outer flow channel may include an outer radial wall forming an outer peripheral boundary of the flowpath. The plurality of scroll stator vanes may be distributed circumferentially about the center axis and extend radially within the flowpath to the outer flow channel. The plurality of scroll stator vanes may include a first scroll stator vane and a second scroll stator vane. The vane passage may extend axially between the first scroll stator vane and the second scroll stator vane. The vane passage may extend radially between the outer flow channel and the annular collection region. The vane passage may be configured to direct gas flow along the flowpath to the annular collection region. The annular collection region may be disposed radially inward of the plurality of scroll stator vanes and extend circumferentially about and axially along the center axis. The annular collection region may be configured to receive gas flow from vane passage. The turbine stator vane assembly may be coupled with the scroll outlet. The turbine stator vane assembly may include a plurality of turbine stator vanes distributed circumferentially about the center axis.

According to any of the aspects and/or embodiments described above and herein, the first scroll stator vane includes a suction side surface and a pressure side surface. The suction side surface extends between a leading edge and a trailing edge. The pressure side surface includes a pressure side (PS) intervane passage portion and a trailing edge (TE) arc annular portion. The PS intervane passage portion extends between the leading edge and the TE arc annular portion. The TE arc annular portion extends between the trailing edge and the PS intervane passage portion.

According to any of the aspects and/or embodiments described above and herein, the turbine stator vane assembly includes a first turbine stator vane and a second turbine stator vane. The first turbine stator vane may include a first angular orientation, and the second turbine stator vane may include a second angular orientation different than the first angular orientation.

According to any of the aspects and/or embodiments described above and herein, the turbine stator vane assembly may include a first circumferential section of turbine stator vanes and a second circumferential section of turbine stator vanes. The first circumferential section of turbine stator vanes may include an angular orientation different than the second circumferential section of turbine stator vanes.

According to an aspect of the present disclosure, an engine assembly is provided. The engine assembly includes a rotary engine, an exhaust manifold, a turbine scroll and an axial turbine. The plurality of rotary units may be in communication with one another, and each rotary unit may include an exhaust port. The exhaust manifold may be connected to the exhaust port of each rotary unit and may be configured to receive a periodic flow of combustion gases from each exhaust port during operation of the engine. The turbine scroll may be in fluid communication with the exhaust manifold and may be configured to receive the periodic flow of combustion gases. The turbine scroll may include a flow channel, a scroll inlet, a plurality of scroll stator vanes, and a plurality of vane passages. The flow channel may be defined by an outer radial wall extending between a first axial sidewall and a second axial sidewall. The first axial sidewall and second axial sidewall may be spaced widthwise apart from one another. The flow channel may extend circumferentially around a center axis. The scroll inlet may be configured to permit gas flow into the flow channel. The plurality of scroll stator vanes may be disposed within the flow channel, spaced apart from one another and disposed around a circumference of the scroll. Each vane passage may be defined between adjacent said scroll stator vanes of the plurality of scroll stator vanes. Each vane passage may be open to an outer flow channel portion of the flow channel disposed radially between the scroll stator vanes and the outer radial wall and is open to an annular region disposed radially inside of the plurality of scroll stator vanes. The vane passages may be configured to direct gas flow in an inwardly spiraling direction having a radially inward component and a circumferential component. The annular region may be disposed radially inboard of the plurality of scroll stator vanes and may be configured to receive gas flow from the plurality of vane passages. The axial turbine may be configured to receive gas flow from the turbine scroll.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic illustration of a rotary engine.

FIG. 2 is a diagrammatic perspective view of an exhaust manifold coupled to a present disclosure scroll embodiment and turbine.

FIG. 3 is a diagrammatic representation of a present disclosure scroll embodiment.

FIGS. 4-7 are diagrammatic representations of a flow channel cross-section.

FIG. 8 is a diagrammatic isometric view of a scroll stator vane embodiment.

FIG. 9 is a diagrammatic isometric view of a scroll stator vane embodiment.

FIGS. 10A-C are diagrammatic illustrations of vane passage configurations.

FIG. 11 is a diagrammatic illustration of a vane passage having gas flow ribs.

FIG. 12 is a diagrammatic representation of a present disclosure scroll embodiment having flow diverters.

FIG. 13 is a diagrammatic cross-sectional view of a present disclosure scroll embodiment, displaying a turbine stator vane assembly and axial turbine.

FIG. 14 is a diagrammatic isometric view of the turbine stator vane assembly of FIG. 13.

FIG. 14A is an enlarged diagrammatic illustration of the turbine stator vane assembly of FIG. 14, along lines A-A.

FIG. 14B is an enlarged diagrammatic illustration of the turbine stator vane assembly of FIG. 14A, along lines B-B.

FIG. 15 is a diagrammatic representation of a present disclosure scroll embodiment.

FIG. 16 is a diagrammatic representation of a present disclosure scroll embodiment.

FIGS. 17A and 17B are diagrammatic illustrations of turbine stator vane configurations.

### DETAILED DESCRIPTION

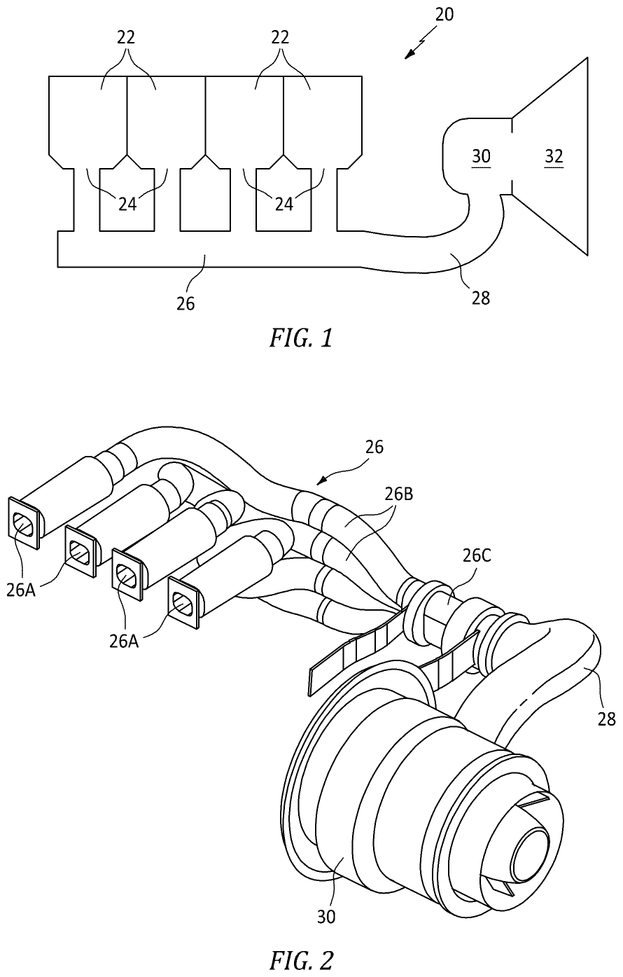

Referring to FIG. 1, an example of an internal combustion engine is diagrammatically shown in the form of a rotary engine 20. The present disclosure is not limited to use with rotary engines. The rotary engine 20 includes a plurality of similar axially aligned rotary units 22 driving a common eccentric shaft. The rotary engine 20 shown diagrammatically in FIG. 1 includes four rotary units 22 but it is understood that the engine 20 could comprise any number of rotary units 22. The present disclosure is not limited to use with any particular rotary engine 20 configuration. Each of the rotary units 22 includes an exhaust port 24 for collecting combustion gases produced in the respective rotary unit 22. The engine 20 includes an exhaust manifold 26 configured to be paired with the exhaust ports 24. An exhaust pipe 28 connects the exhaust manifold 26 to a scroll 30 (sometimes referred to as a “volute”) that organizes the combustion gases for entry into a turbine 32. The turbine 32 may be connected to compressor (not shown) that draws in air and provides it to the rotary engine 20 for use in combustion.

FIG. 2 illustrates an embodiment of an exhaust manifold 26 (sometimes referred to as an “exhaust header”) that includes an initial segment 26A for each rotary unit 22 and a respective manifold pipe 26B extending from each initial segment 26A to a collector 26C. As can be seen in FIG. 2, each of the manifold pipes 26B (four shown in the exemplary exhaust manifold 26) are combined into the collector 26C. In the exhaust manifold 26 example shown in FIG. 2, the manifold pipes 26B are combined into the collector 26C in a stacked arrangement and the collector 26C is oblong or oval shaped. In alternative embodiments, the collector 26C may be circular. The present disclosure is not limited to this particular collector 26C configuration. The manifold pipes 26B are typically configured (e.g., length, diameter, routing, and the like) so that the combustion gases exiting each rotary unit 22 are subjected to a similar pressure and flow profile. In this manner, the operating parameters of each rotary unit 22 are made as uniform as possible, thereby facilitating collective operation of the rotary units 22 of the rotary engine 20. An exhaust pipe 28 extends between the exhaust manifold collector 26C and the inlet of the scroll 30. In those embodiments wherein the collector 26C is oblong/oval shaped, the exhaust pipe 28 between the collector 26C and the inlet of the scroll 30 may also be oblong/oval shaped.

The scroll 30 embodiment shown in FIG. 2 may be described as a single port annular scroll; i.e., the combustion gases from the exhaust manifold 26 are directed into a single port of the annular scroll 30. The scroll 30 is configured to organize the combustion gases to produce a flow of combustion gases exiting the scroll 30 and entering the turbine 32 at a high tangential velocity; i.e., a high exit swirl.

Each rotary unit 22 of the rotary engine 20 operates in a cyclic manner, periodically producing combustion gases. The collective flow of combustion gases from the rotary engine 20, therefore, includes a periodic portion that may be referred to as “pulsation portion”. The combustion gases exiting a conventional scroll (i.e., entering the turbine inlet) typically have circumferential and radial flow nonuniformities as a function of time. In other words, the aforesaid non-uniformities may be spatially disposed (e.g., circumferentially, radially) and variable as a function of time. This non-uniform gas flow entering the turbine very often decreases the turbine (isentropic) efficiency and subjects the turbine to periodic excitation forces that over time can cause structural effects; e.g., fatigue. Historically, some axial turbines have addressed this issue by adding one or more turbine initial stages (sometimes referred to as a “sacrificial stages”) configured to mitigate or “settle” the gas flow non-uniformities. Disadvantages to this approach include the greater size, additional weight, and additional cost associated with sacrificial turbine stages.

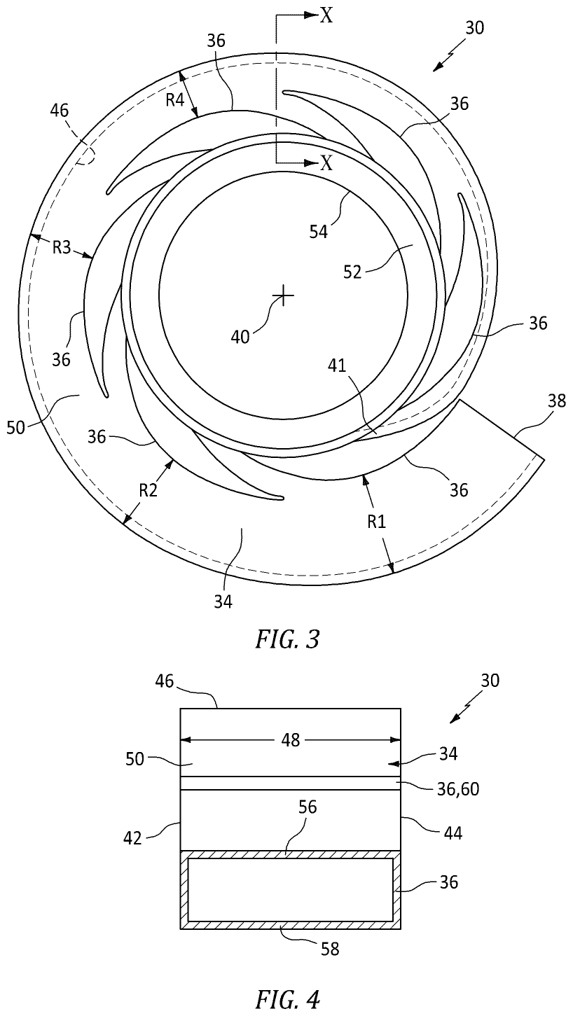

Referring to FIG. 3, the present disclosure scroll 30 is configured to attenuate the pulsatile portion of the combustion gas flow and thereby increase turbine efficiency and decrease periodic excitation forces potentially detrimental to the turbine. The present disclosure scroll may be used, for example, with an axial reaction turbine, an axial impulse turbine, or the like.

The present disclosure scroll 30 includes a generally annularly extending flow channel 34, a plurality of scroll stator vanes 36, and a scroll inlet 38. The scroll stator vanes 36 are disposed in the flow channel 34, spaced apart from one another and disposed around the circumference of the scroll 30. The scroll 30 includes a center axis 40. The flow channel 34 extends from the scroll inlet 38 to a terminal end 41 disposed at a vane passage 68 as will be described herein. The scroll inlet 38 may be aligned with a stator vane 36.

The flow channel 34 may be defined by a first axial sidewall 42, a second axial sidewall 44, and an outer radial wall 46. The first and second axial sidewalls 42, 44 are axially (i.e., “widthwise”) spaced apart from one another. The outer radial wall 46 extends between the first and second axial sidewalls 42, 44 and defines the outer radial extent of the flow channel 34. FIG. 3 diagrammatically illustrates a side view of a present disclosure scroll 30 embodiment, shown open (e.g., an axial sidewall removed) to permit the scroll stator vanes 36 to be seen. In the planar view of FIG. 3, the center axis 40 extends perpendicularly, into and out of the page. FIGS. 4-7 diagrammatically show scroll 30 cross-sections taken at section X-X to illustrate different flow channel 34 configurations.

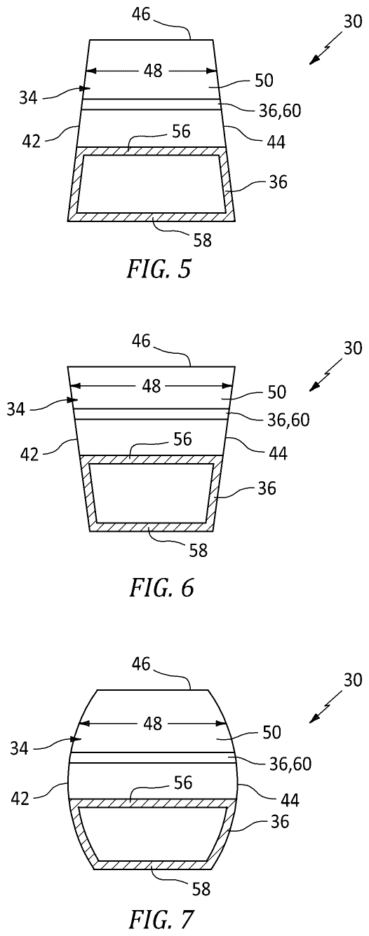

In some embodiments, the first and second axial sidewalls 42, 44 and the outer radial wall 46 may form a flow channel 34 having a rectangular-like cross-section wherein the first and second axial sidewalls 42, 44 are substantially parallel one another and the outer radial wall 46 is substantially perpendicular to the first and second axial sidewalls 42, 44; e.g., see FIG. 3. In these embodiments, the width 48 of the flow channel 34 may be substantially constant. In some embodiments, the first and second axial sidewalls 42, 44 may converge or diverge from one another to produce a varying flow channel 34 width between the outer radial limit of the flow channel 34 (i.e., at the outer radial wall 46) and the inner radial limit of the flow channel 34; e.g., see FIGS. 5 and 6. In other embodiments, one or both of the first and second axial sidewalls 42, 44 may not be planar and the first and second axial sidewalls 42, 44 may not therefore be parallel one another. For example, one or both of the first and second axial sidewalls 42, 44 may be arcuately shaped; e.g., the arcuately shaped first and/or second axial sidewall 42, 44 may curve away from the other of the first and/or second axial sidewall 42, 44 to produce a flow channel 34 width that varies between the outer radial limit of the flow channel 34 (i.e., at the outer radial wall 46) and the inner radial limit of the flow channel 34; e.g., see FIG. 7. The flow channel 34 configurations shown in FIGS. 3-7 are non-limiting examples.

The intersection between the outer radial wall 46 and one or both the first and second axial sidewalls 42, 44 may have different configurations. For example, the outer radial wall 46 may intersect directly with an axial sidewall 42, 44 (e.g., a perpendicular intersection), or the intersection between the outer radial wall 46 and an axial sidewall 42, 44 may be radiused, or a fillet surface (e.g., planar or arcuate) may extend between the outer radial wall 46 and the axial sidewall 42, 44 proximate the intersection. The present disclosure is not limited to any particular outer radial wall 46 and axial sidewall 42, 44 intersection configuration.

In some embodiments (e.g., see FIG. 3), the outer radial wall 46 may be a planar surface. In some embodiments, the outer radial wall 46 may be arcuately shaped. The present disclosure is not limited to any particular outer radial wall 46 configuration.

The outer radial wall 46 is disposed radially outside of the scroll stator vanes 36 and is spaced apart from the outer radial surface of each scroll stator vane 36 (e.g., the suction side surface 56 of the respective scroll stator vane 36) by a distance R; e.g., R1 for a first scroll stator vane 36, R2 for a second scroll stator vane 36, R3 for a third scroll stator vane 36, and the like. The portion of the flow channel 34 disposed between the suction side surface 56 of a respective scroll stator vane 36 and the outer radial wall 46 may be referred to as the “outer flow channel portion 50”.

In some embodiments (e.g., see FIG. 3), the outer radial wall 46 spirals inwardly starting at the scroll inlet 38 as the outer radial wall 46 extends circumferentially around the scroll 30. In this embodiment, the outer radial wall 46 may be described as non-axisymmetric (about the center axis 40). The inward spiral of the outer radial wall 46 can be seen by the change in radial distances R between the scroll stator vanes 36 and the outer radial wall 46 as the flow channel 34 extends circumferentially from the scroll inlet 38; e.g., R1>R2>R3, and so on. In these outer radial wall 46 non-axisymmetric embodiments, the cross-sectional area of the outer flow channel portion 50 (i.e., in a plane perpendicular to the flow channel 34 and to the collective circumferential direction of flow within the channel 34) decreases in the spiral direction away from the scroll inlet 38. In some embodiments, the flow channel 34 with an outer flow channel portion 50 having a cross-sectional area that decreases in a circumferential direction (as a result of the non-axisymmetric outer radial wall 46) may be described as extending from the scroll inlet 38 to the terminal end 41 where the outer flow channel portion 50 terminates at a vane passage 68; e.g., see FIG. 3. The present disclosure flow channel is not limited to this embodiment.

In some embodiments, the outer radial wall 46 may extend circumferentially around the scroll 30 at a constant spacing from the scroll stator vanes 36 and the radial distances between the scroll stator vanes 36 and the outer radial wall 46 remain constant; e.g., R1=R2=R3, and so on. In these outer radial wall 46 axisymmetric embodiments (symmetric about the center axis 40), the cross-sectional area of the outer flow channel portion 50 remains constant in the spiral direction away from the scroll inlet 38.

The scroll stator vanes 36 are configured to direct air traveling circumferentially within the flow channel 34 radially inwardly into an annular region 52 disposed radially between the scroll stator vanes 36 and a turbine annulus 54. The aforesaid annular region 52 may be referred to as an “annular collection region 52”. The gas flow entering the annular collection region 52 subsequently passes axially into the turbine while maintaining its angular momentum.

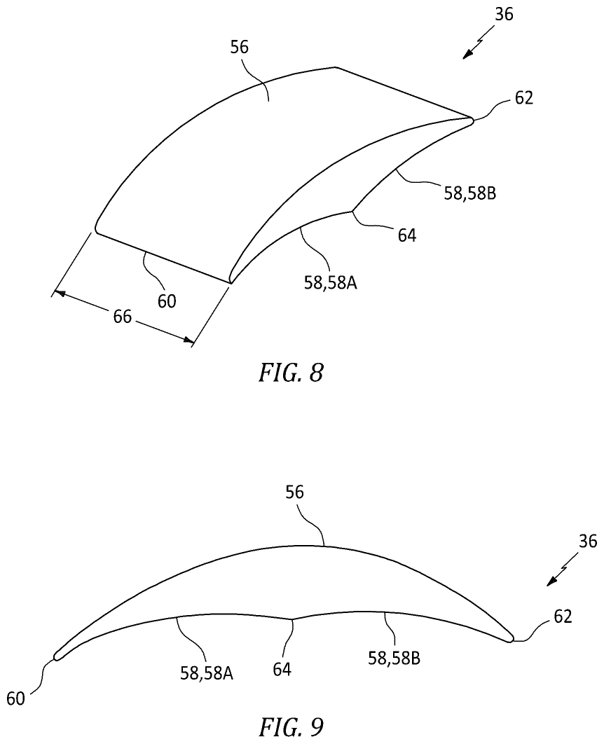

Referring to FIGS. 8 and 9, in the embodiment shown in FIGS. 3, 8, and 9, each scroll stator vane 36 has a suction side surface 56, a pressure side surface 58, a leading edge 60, and a trailing edge 62. The pressure side surface 58 includes a pressure side (PS) intervane passage portion 58A and a trailing edge (TE) annular passage portion 58B. The PS intervane passage portion 58A extends from the leading edge 60 to the TE arc annular portion 58B, and the TE arc annular portion 58B extends from the trailing edge 62 to the PS intervane passage portion 58A. The PS intervane passage portion 58A and the TE arc annular portion 58B may meet at an inflection point 64. The TE arc annular portions 58B of the scroll stator vanes define an outer radial perimeter of the annular collection region 52. Each scroll stator vane 36 has a width 66 that extends between the axial sidewalls 42, 44 of the flow channel 34. The leading edge 60 of a scroll stator vane 36 may be arcuately configured (e.g., as a radiused surface that is parti-circular or parti-elliptical, or the like), and the trailing edge 62 of a scroll stator vane 36 may be arcuately configured (e.g., as a radiused surface that is parti-circular or parti-elliptical, or the like). The present disclosure is not limited to the scroll stator vane 36 embodiment shown in FIGS. 3, 8, and 9, and the present disclosure is not limited to embodiments wherein all of the scroll stator vanes 36 are the configured the same.

In some embodiments, the pressure side surface 58 and the suction side surface 56 of each scroll stator vane 36 extend widthwise between and intersect with the first and second axial sidewalls 42, 44 of the flow channel 34. The pressure side and suction side surfaces 56, 58 may intersect directly with an axial sidewall 42, 44 (e.g., a perpendicular intersection), or the intersection may be radiused, or a fillet surface (e.g., planar or arcuate) may extend therebetween, or there may be an undercut disposed between the pressure side surface 58 and an axial sidewall 42, 44 and/or between the suction side surface 56 and an axial sidewall 42, 44; e.g., where one or both respective axial sidewalls 42, 44 are shaped inwardly at the pressure side surface 58 and/or the suction side surface 56. Some sidewall configurations of this type may be described as having a “C” like shape. The present disclosure is not limited to any particular intersection configuration between the pressure side surface 58 and a flow channel axial sidewall 42, 44, or between the suction side surface 56 and a flow channel axial sidewall 42, 44. In some embodiments, a scroll stator vane 36 may be configured to extend widthwise between, but not intersect with, the first axial sidewall 42 and/or the second axial sidewall 44 of the flow channel 34. In those embodiments wherein a scroll stator vane 36 extends widthwise between but does not intersect with an axial sidewall 42, 44, the scroll stator vane 36 may be spaced apart from the respective axial sidewall 42, 44.

As stated above, the scroll stator vanes 36 are disposed in the flow channel 34, spaced apart from one another and disposed around the circumference of the scroll 30. The present disclosure scroll 30 diagrammatically shown in FIG. 3 is shown with six (6) scroll stator vanes 36 spaced apart from one another and disposed around the circumference of the scroll 30. Embodiments of the present disclosure scroll 30 may have as few as two (2) scroll stator vanes 36 and may include more than six (6) scroll stator vanes 36. The present disclosure is not limited to any particular number of scroll stator vanes 36.

The circumferential spacing of the scroll stator vanes 36 produces a vane passage 68 disposed between each pair of adjacent scroll stator vanes 36; e.g., a vane passage 68 is formed between forward and aft adjacent scroll stator vanes 36 within the flow channel 34. A first point in the flow channel 34 that encounters the circumferential flow in the flow channel 34 before a second point is said to be “forward” or “upstream” of the second point, or conversely the second point is said to be “aft” or “downstream” of the first point. More specifically, each vane passage 68 between adjacent forward and aft scroll stator vanes 36 is defined by a portion of the suction side surface 56 of a forward scroll stator vane 36 and the PS intervane passage portion 58A of the adjacent aft scroll stator vane 36. Each vane passage 68 may extend in a direction that has a radial component and a circumferential component (i.e., the vane passage 68 spirals inwardly), as shown in FIG. 3. Each vane passage 68 extends a length 70 between the outer flow channel portion 50 and the annular collection region 52. In some embodiments, the scroll stator vanes 36 may be configured to define a vane passage 68 having length over width ratio (which may be referred to as a length over hydraulic diameter ratio, or L/Dh) greater than one (1) to impart desirable flow directionality and tangential velocity. In each vane passage 68, the distance between the portion of the suction side surface 56 of the forward scroll stator vane 36 and the PS intervane passage portion 58A of the adjacent aft scroll stator vane 36 may be referred to as the “height” or “H” of the vane passage 68.

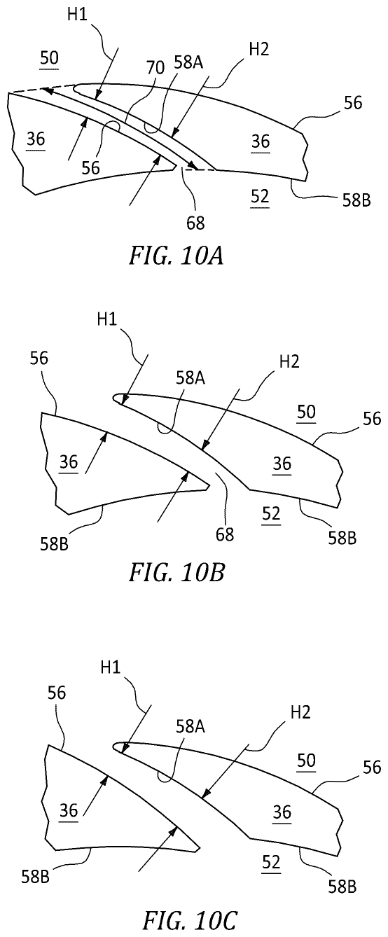

Referring to FIGS. 10A-C, in some embodiments adjacent scroll stator vanes 36 may be configured such that the vane passage 68 therebetween has a uniform height along the vane passage length 70; see FIG. 10A, H1=H2. In some embodiments, adjacent scroll stator vanes 36 may be configured such that the vane passage 68 therebetween converges along the vane passage length 70 between the outer flow channel portion 50 and the annular collection region 52; e.g., see FIG. 10B, H1>H2. In some embodiments, adjacent scroll stator vanes 36 may be configured such that the vane passage 68 therebetween diverges along the vane passage length 70 between the outer flow channel portion 50 and the annular collection region 52; e.g., see FIG. 10C, H1<H2.

In some embodiments, like that diagrammatically shown in FIG. 3, the scroll stator vanes 36 may be uniformly configured and uniformly spaced around the circumference of the scroll 30, which produces uniformly configured vane passages 68; e.g., all vane passages 68 have the same geometric configuration. In a “uniform” scroll/scroll stator vane 36 configuration like this, the gas flow will enter the annular collection region 52 at equidistant circumferential points; e.g., in a scroll configuration having six (6) uniform scroll stator vanes 36, vane passages 68 are disposed at sixty degrees (60°) angular spacings. The present disclosure is not, however, limited to this uniform configuration. For example, in some embodiments the scroll stator vanes 36 may not be uniformly configured, but rather configured to define vane passages 68 that are not circumferentially equidistant one another; e.g., assuming six (6) scroll stator vanes 36, all vane passages 68 may not be disposed at sixty degree (60°) angular spacings. As will be described herein, the present disclosure scroll 30 is configured to increase the uniformity of the gas flow into the turbine. In some applications, the gas flow entering the scroll 30 may be such that gas flow entering the annular collection region 52 from circumferentially equidistant positioned vane passages 68 may improve the uniformity of the gas flow into the turbine, or conversely in some applications gas flow entering the scroll 30 may be such that gas flow entering the annular collection region 52 from circumferentially non-equidistant positioned vane passages 68 may improve the uniformity of the gas flow into the turbine.

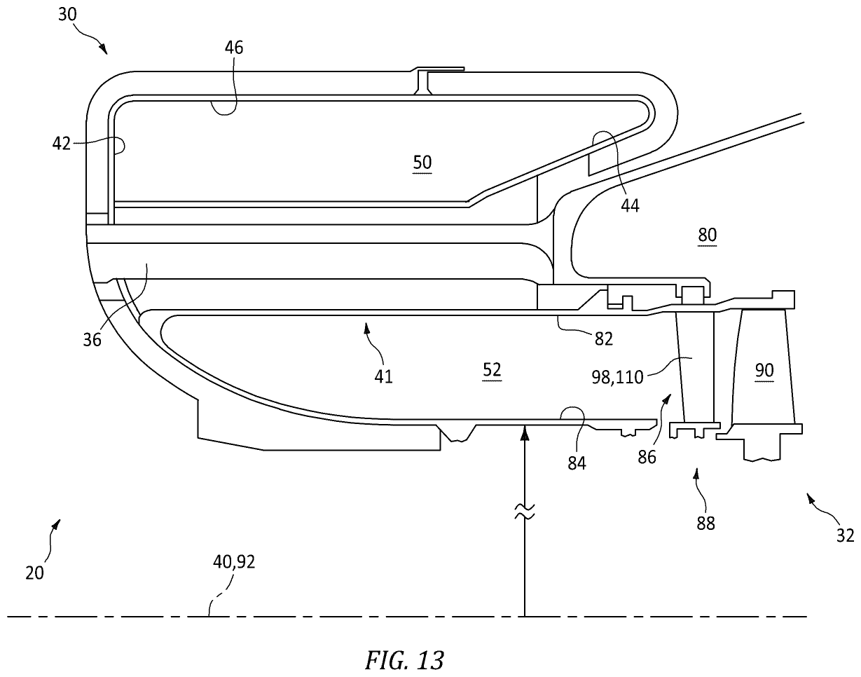

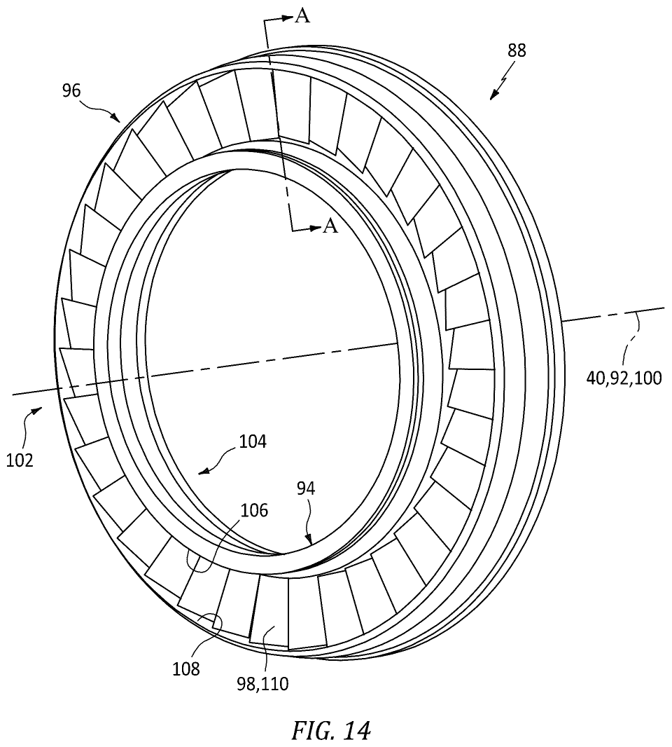

Referring now to FIG. 13, the scroll stator vanes 36 are disposed within a flowpath radially between the outer flow channel portion 50 and the annular collection region 52. The radial and circumferential gas flow entering the annular collection region 52 along the flowpath is converted to an axial and circumferential gas flow subsequently passes axially along the annular collection region 52 into the turbine 32. The annular collection region 52 is therefore configured in fluid communication with the vane passages 68 and is bounded radially by an outer radial perimeter 82 of the annular collection region 52 and an inner radial perimeter 84 of the annular collection region 52.

The outer radial perimeter 82 of the annular collection region 52 forms an outer peripheral boundary of the gas flow moving axially within the annular collection region 52 towards a scroll outlet 86 and the inner radial perimeter 84 of the annular collection region 52 forms an inner peripheral boundary of the gas flow moving axially within the annular collection region 52 towards the scroll outlet 86. The scroll 30 is operatively coupled with a turbine stator vane assembly 88 of the turbine 32 proximate (e.g., at, within, adjacent) the scroll outlet 86. The turbine 32 of FIG. 13, for example, comprises an axial turbine including a plurality of bladed rotors 90 (one rotor shown in FIG. 13) disposed downstream of the turbine stator vane assembly 88. The plurality of bladed rotors 90 are configured for rotation about an axial centerline 92. The centerline 92 may also or alternatively be a rotational axis of one or more components (e.g., rotors) of the rotary engine 20 and/or the center axis 40 of the scroll 30 in general. In some embodiments, the turbine 32 may comprise a multi-stage turbine 32 including a plurality of turbine stator vane assemblies 88 disposed between bladed rotor stages of the axial turbine.

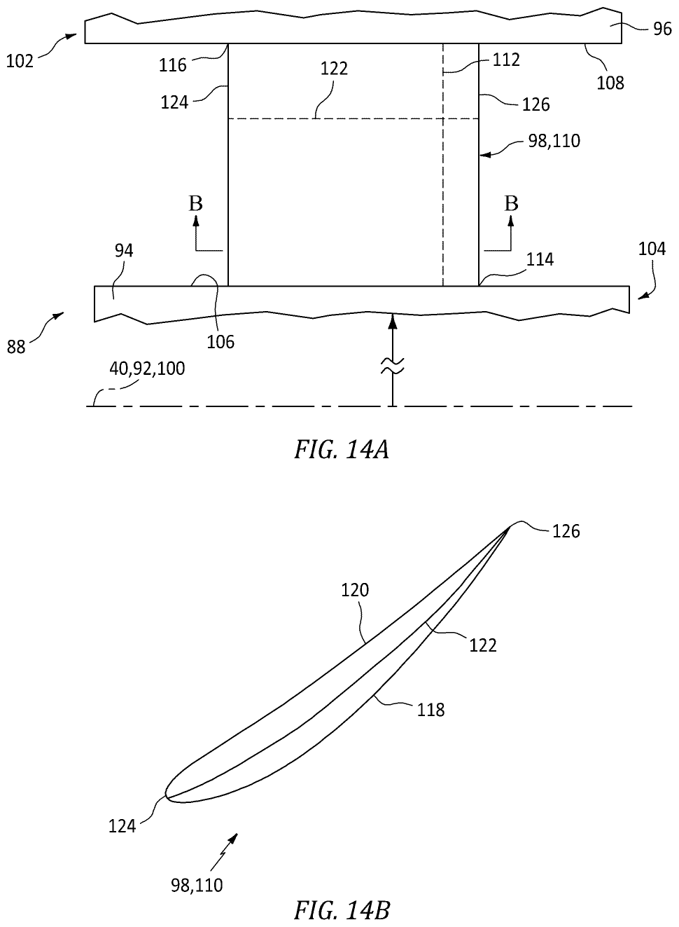

Referring now to FIGS. 14 and 14A, the turbine stator vane assembly 88 for the turbine 32 is depicted. The turbine stator vane assembly 88 includes an inner hub 94, an outer platform 96, and a plurality of turbine stator vanes 98. The inner hub 94 and the outer platform 96 of FIGS. 14 and 14A extend axially along an axis 100 between and to an upstream end 102 of the assembly 88 and a downstream end 104 of the assembly 88. The axis 100 may be, for example, the axial centerline 92, a centerline axis of one or more other components of the rotary engine 20 and/or the center axis 40 in general. The inner hub 94 and the outer platform 96 extend circumferentially about (e.g., completely around) the axis 100. An inner hub outer radial surface 106 is configured to form an inner peripheral boundary of the gas flow through the assembly 88, and an outer platform inner radial surface 108 is configured to form an outer peripheral boundary of the gas flowpath through the assembly 88.

The turbine stator vanes 98 of FIGS. 14 and 14A are arranged circumferentially about the axis 100. Each turbine stator vane 98 includes an airfoil 110. Each turbine stator vane 98 and airfoil 110 extend radially (relative to the axis 100) from the inner hub outer radial surface 106 and the outer platform inner radial surface 108. Each turbine stator vane 98 and airfoil 110 may be connected to (e.g., formed integral with or otherwise attached to) the inner hub 94 and the outer platform 96.

Each airfoil 110 of FIG. 14A extends spanwise along a span line 112 of the airfoil 110 between and to a (e.g., radial inner) base 114 of the airfoil 110 and a (e.g., radial outer) tip 116 of the airfoil 110. The airfoil base 114 is adjacent the inner hub outer radial surface 106 and may be connected to the inner hub 94. The airfoil tip 116 is adjacent the outer platform inner radial surface 108 and may be connected to the outer platform 96. With additional reference to FIG. 14B, the airfoil 110 extends laterally for a thickness of the airfoil 110 between and to a first side 118 of the airfoil 110 and a second side 120 of the airfoil 110. The airfoil 100 extends chordwise along a camber line 122 of the airfoil 110 from a leading edge 124 of the airfoil 110 to a trailing edge 126 of the airfoil 110.

In some embodiments, like that shown in FIG. 3, the scroll stator vane 36 features (e.g., the suction side surface 56, the pressure side surface 58, the leading edge 60, the trailing edge 62) may extend widthwise parallel to the center axis 40 of the scroll 30. In some embodiments, the scroll stator vane 36 features (e.g., the suction side surface 56, the pressure side surface 58, the leading edge 60, the trailing edge 62) may have an axial twist in a widthwise direction and are not therefore parallel to the center axis 40 of the scroll 30. Here again, the present disclosure scroll 30 is configured to increase the uniformity of the gas flow into the turbine. In some applications, one or more scroll stator vanes 36 having features with an axial twist in a widthwise direction may be included to improve the uniformity of the gas flow into the turbine.

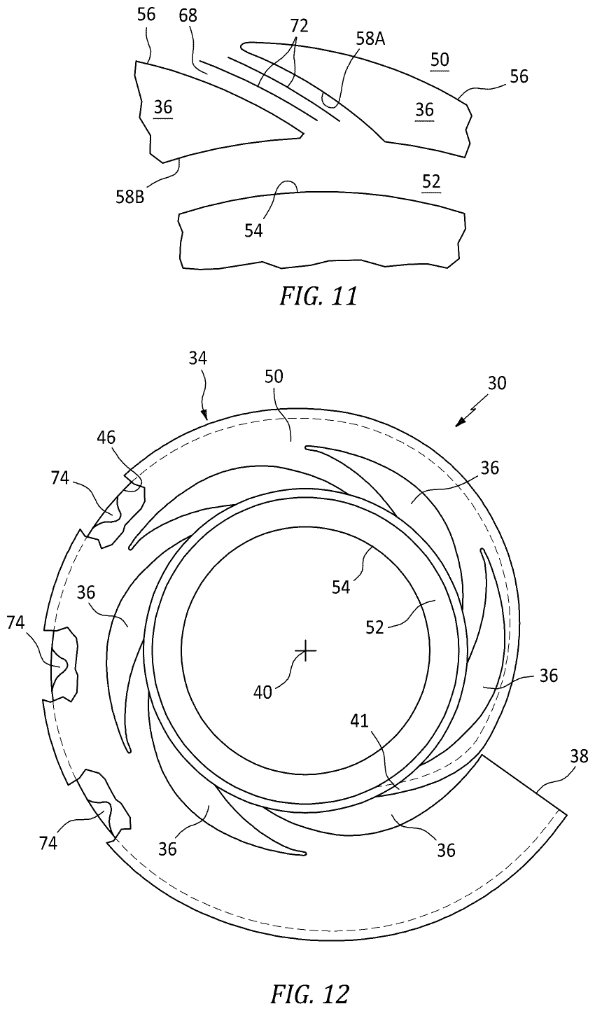

Referring to FIG. 11, in some embodiments, one or more gas flow guide panels 72 may be disposed within a vane passage 68 to facilitate guiding gas flow passing through a vane passage 68. In some configurations, the gas flow panels 72 may be configured to provide structural stiffening of the vane passage 68. A gas flow guide panel 72 may extend widthwise a portion or all of the distance between the axial sidewalls 42, 44. In some embodiments, a gas flow guide panel 72 may include a first portion connected to a first of the axial sidewalls 42, 44, extending toward the opposite axial sidewall, and a second portion connected to the other of the axial sidewalls 42, 44, extending toward the opposite axial sidewall. A gas flow guide panel 72 may extend a portion or all of the length of a vane passage 68.

In some embodiments, the scroll stator vanes 36 may be mounted so as to be pivotable within the flow channel 34 and connected to an actuating device (not shown) configured to pivot the scroll stator vanes 36; e.g., to change the angle of attack of the leading edge 60 relative to the gas flow traveling circumferentially within the flow channel 34.

In some embodiments, one or more flow diverters 74 (sometimes referred to as “ski jumps”) may be attached to an interior surface of the flow channel 34. A flow diverter 74 may be attached to a surface and be configured to divert flow away from the surface to which the flow diverter 74 is attached. In FIG. 12 for example, a plurality of flow diverters 74 are shown attached to the outer radial wall 46 of the flow channel 34 to divert circumferential flow within the flow channel 34 away from the outer radial wall 46 and more generally toward the radially inward scroll stator vanes 36.

In some embodiments, the scroll stator vanes 36 may be hollow bodies. In those embodiments, the interior cavity of a scroll stator vane 36 (defined at least in part by the suction side surface and the pressure side surface) may include structural elements (e.g., ribs, struts, and the like). Alternatively and/or additionally, the interior cavity of the scroll stator vane 36 may be configured with or otherwise include a tube 78 extending withing the interior cavity of the scroll stator vane 36 and in communication with an exterior region 80 of the scroll 30 (see FIG. 13). In some embodiments, an exterior surface of a scroll stator vane 36 may include elements (e.g., ribs) that provide structural support and/or may function to guide gas flow. In some embodiments, one or more struts may extend within the flow channel 34 to support a scroll stator vane 36.

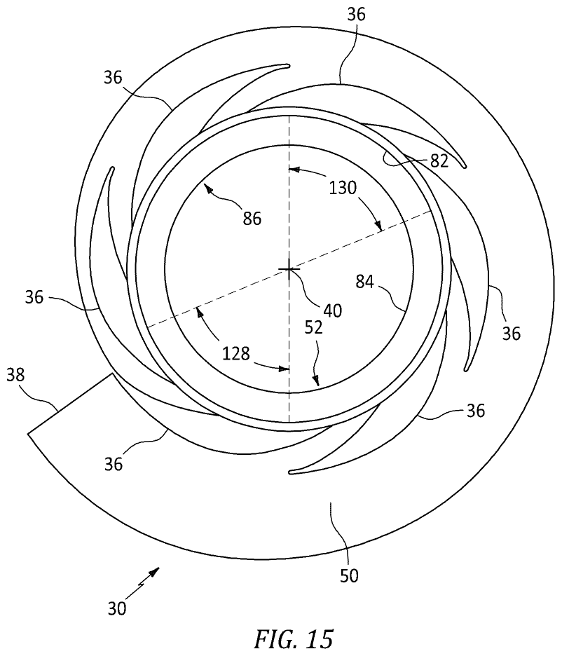

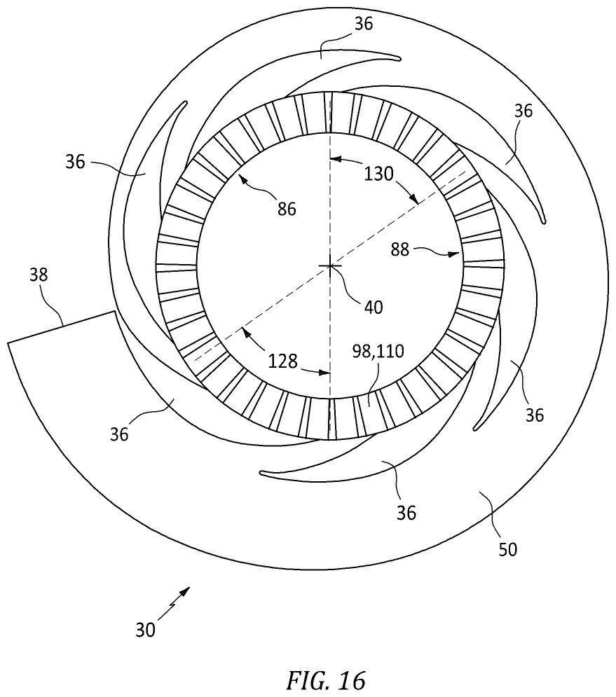

FIG. 15 depicts a diagrammatic turbine scroll 30 at the end including the scroll outlet 86 and the annular collection region 52. For ease of description, the scroll 30 of FIG. 15 is depicted without the turbine stator vane assembly 88. In some embodiments, a flow pattern through a first circumferential section 128 of the annular collection region 52 may be different than a second circumferential section 130 of the annular collection region 52. The first and second circumferential sections 128 and 130 may be, for example a portion of the circumference of the annular collection region 52. Due to the circumferential asymmetry of gas flow moving along a flowpath of the scroll 30, referring now to FIG. 16, an arrangement (e.g., orientation) of the turbine stator vanes 98 of the turbine stator vane assembly 88 can be configured to further increase uniformity of gas flow entering the turbine 32. The turbine stator vanes 98 forming the turbine stator vane assembly 88 of FIG. 16, for example, may thereby be configured in an asymmetrical arrangement circumferentially about the center axis 40 to increase uniformity of gas flow exiting the scroll 30 within the different circumferential sections 128, 130 of the annular collection region 52. Stated differently, an orientation of the turbine stator vanes 98 arranged with (e.g., aligned with/receiving gas flow from) the first circumferential section 128 of the annular collection region 52 may be different than the orientation of the turbine stator vanes 98 arranged with (e.g., aligned with/receiving gas flow from) the second circumferential section 130 of the annular collection region 52. The orientation may include, but is not limited to, a circumferential spacing between neighboring turbine stator vanes 98 and/or an angular orientation of the turbine stator vanes 98.

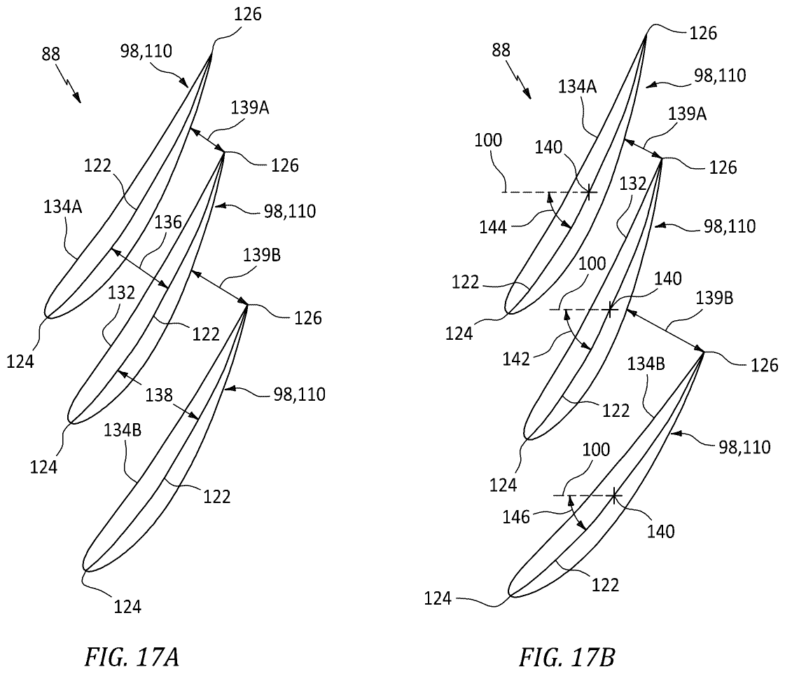

Referring now to FIGS. 17A and 17B, neighboring pairs of airfoils 110 may be configured to include different distances between adjacent airfoils 110 (see FIG. 17A) and/or may be configured to include different angular orientations between adjacent airfoils 110 (see FIG. 17B). The airfoil arrangements of FIGS. 17A-B are configured to further improve flow non-uniformity, leading to increased turbine efficiency and reduced turbine excitation pulse magnitude.

Referring to FIG. 17A, a first airfoil 132 is arranged circumferentially along the turbine stator vane assembly 88 between an adjacent second airfoil 134A and an adjacent third airfoil 134B (referred to generally as “neighboring airfoils 134”). The first airfoil 132 of FIG. 17A, for example, may be laterally (e.g., circumferentially) spaced from the second airfoil 134A by a first offset distance 136. The first airfoil 132 may be laterally (e.g., circumferentially) spaced from the third airfoil 134B by a second offset distance 138. The first and second offset distances 136 and 138 may be, for example, a distance between the camber lines 122 of the first airfoil 132 and the camber line 122 of a respective one of the neighboring airfoils 134. The first offset distance 136 may be different than (e.g., greater than, less than) the second offset distance 138. For example, the first offset distance 136 may be between about twenty-five percent (25%) to about seventy-five percent (75%) of the second offset distance 138, generally, though in some embodiments the first offset distance 136 may be between about thirty percent (30%) to about fifty percent (50%) of the second offset distance 138. Other ranges of the offset distances 136, 138 are not meant to be precluded.

The first offset distance 136 and the second offset distance 138 may thereby change a vane throat area 139A and 139B between the first airfoil 132 and the neighboring airfoils 134. For example, a first vane throat area 139A between the trailing edge 126 of the first airfoil 132 and the adjacent second airfoil 134A may be different than (e.g., less than, greater than) a second vane throat area 139B between the first airfoil 132 and the adjacent third airfoil 134B.

Referring to FIG. 17B, the first airfoil 132 is arranged circumferentially along the turbine stator vane assembly 88 between adjacent neighboring airfoils 134. The leading edge 124 of each airfoil 110 (e.g., the first airfoil 132 and the neighboring airfoils 134) may be angularly offset from the axis 100 of the turbine stator vane assembly 88 to provide an angular orientation of the respective airfoil 110. Stated differently, each airfoil 110 along the turbine stator vane assembly 88 may be pivoted about a pivot axis 140 to orient (e.g., rotate) the camber line 122 about the pivot axis 140. The first airfoil 132 of FIG. 17B, for example, may include a first offset angle 142 between the axis 100 and the camber line 122 of the first airfoil 132. The second airfoil 134A may include a second offset angle 144 between the axis 100 and the camber line 122 of the second airfoil 134A. The second offset angle 144 may be different than (e.g., less than or greater than) the first offset angle 142. The third airfoil 134B may include a third offset angle 146 between the axis 100 and the camber line 122 of the third airfoil 134B. The third offset angle 146 may be different than (e.g., less than or greater than) the first offset angle 142. The third offset angle 146 may be different than (e.g., less than or greater than) the second offset angle 144. The second offset angle 144 and/or the third offset angle 146 may be angularly offset from the first offset angle 142 by rotating a respective one of the neighboring airfoils 144 about the pivot axis 140 in a clockwise direction and/or a counterclockwise direction. In some embodiments, the first offset angle 142 may be within plus or minus ten degrees of the second offset angle 144. Other ranges of difference between the first offset angle 142 and the second offset angle 144 are not meant to be precluded.

The respective offset angles 142, 144, 146 of the first airfoil 132, the adjacent second airfoil 134A, and/or the adjacent third airfoil 134B may thereby change the vane throat area 139A and 139B between the first airfoil 132 and the neighboring airfoils 134. For example, the first vane throat area 139A between the first airfoil 132 and the adjacent second airfoil 134A may be different than (e.g., less than, greater than) the second vane throat area 139B between the first airfoil 132 and the adjacent third airfoil 134B.

The airfoil arrangements of FIGS. 17A and 17B may provide a change in a vane throat area to re-distribute flow circumferentially in the region (e.g., an annulus) upstream of the turbine stator vane assembly 88. In contrast to conventional assemblies, which often sacrifice the first stage to settle partial admission flow, the turbine stator vane assembly 88 of the present disclosure thereby reduces the number of turbine stages necessary for the axial turbine while increasing turbine (isentropic) efficiency and reduced turbine excitation pulse magnitude. In some embodiments, the airfoil configuration of the turbine stator vane assembly 88 (see e.g., FIGS. 17A and 17B) of the present disclosure may be incorporated into subsequent downstream vane stages of an axial turbine including multiple vane stages to further increase turbine efficiency and reduce turbine excitation pulse magnitude.

As stated above, embodiments of the present disclosure scroll are configured to increase the uniformity of gas entering the turbine, including mitigating the pulsed portion of the combustion gas flow and thereby decrease the entry of pulsed gas flow into the turbine. The scroll embodiment described above having an outer radial wall 46 that extends non-axisymmetrically relative to the center axis 40 of the scroll (i.e., a radially inward spiral) and thereby creates an outer flow channel 34 cross-sectional area that decreases in the spiral direction away from the scroll inlet is understood to provide particular utility. The radially decreasing outer flow channel 34 facilitates guiding gas flow towards the scroll stator vanes 36 and vane passages 68. It is understood that the radially decreasing outer flow channel 34 improves gas flow velocity uniformity (e.g., a nearly uniform Mach number as a function of time) circumferentially within the flow channel 34, which in turn attenuates gas flow pulsation, decreases circumferential and radial flow nonuniformity as a function of time, and maintains and/or generates high tangential gas flow velocity (i.e., high exit swirl) prior to the turbine. The decrease in pulsatile flow is also understood to provide noise reduction.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. The term “surface” as used may include a single surface or may include a plurality of surface sections that collectively form a surface. Hence, the term “surface” is not intended to be limited to a single planar surface. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

What is claimed is:

1. A turbine scroll assembly for use with an axial turbine, comprising:
a turbine scroll including a flowpath, a flow channel, a plurality of scroll stator vanes and an annular collection region, the flowpath extending along the turbine scroll from a scroll inlet to a scroll outlet, the flow channel defined by an outer radial wall extending between a first axial sidewall and a second axial sidewall, the first axial sidewall and second axial sidewall spaced widthwise apart from one another, the flow channel extending circumferentially around a center axis to a terminal end, the plurality of scroll stator vanes distributed circumferentially about the center axis, the plurality of scroll stator vanes disposed within the flow channel, the annular collection region disposed radially inward of the flow channel, the annular collection region extending circumferentially about and axially along the center axis, and the annular collection region configured to receive gas flow from the flow channel; and
a turbine stator vane assembly disposed proximate the scroll outlet, the turbine stator vane assembly including a plurality of turbine stator vanes distributed circumferentially about the center axis.

2. The assembly of claim 1, wherein
the turbine scroll further comprises a plurality of vane passages, each of the plurality of vane passages defined between adjacent scroll stator vanes of the plurality of scroll stator vanes, and each of the plurality of vane passages open to an outer flow channel portion of the flow channel and extending to the terminal end of the flow channel;
the outer flow channel portion disposed radially between the plurality of scroll stator vanes and the outer radial wall; and
each of the plurality of vane passages configured to direct gas flow to the annular collection region.

3. The assembly of claim 1, wherein the annular collection region is arranged along the flowpath between the plurality of scroll stator vanes and the turbine stator vane assembly.

4. The assembly of claim 3, wherein the annular collection region extends axially between the terminal end of the flow channel and the scroll outlet.

5. The assembly of claim 1, wherein
the turbine stator vane assembly includes an inner radial hub and an outer radial hub, the inner radial hub extending axially along the center axis, and the outer radial hub extending axially along the center axis;
the plurality of turbine stator vanes extend spanwise between and are connected to the inner radial hub and the outer radial hub;
the inner radial hub forms an inner peripheral boundary of the flowpath; and
the outer radial hub forms an outer peripheral boundary of the flowpath.

6. The assembly of claim 1, wherein
the plurality of turbine stator vanes include a first turbine stator vane;
a first neighboring turbine stator vane is circumferentially offset from the first turbine stator vane by a first offset distance;
a second neighboring turbine stator vane is circumferentially offset from the first turbine stator vane by a second offset distance; and
the first offset distance is different than the second offset distance.

7. The assembly of claim 1, wherein
the plurality of turbine stator vanes include a first turbine stator vane;
a first neighboring turbine stator vane is angularly offset from the first turbine stator vane by a first offset angle;
a second neighboring turbine stator vane is angularly offset from the first turbine stator vane by a second offset angle; and
the first offset angle is different than the second offset angle.

8. The assembly of claim 7, wherein
the first neighboring turbine stator vane is angularly offset from the first turbine stator vane in a clockwise direction; and
the second neighboring turbine stator vane is angularly offset from the first turbine stator vane in the clockwise direction or a counterclockwise direction.

9. The assembly of claim 1, wherein
each of the plurality of scroll stator vanes is configured with a hollow interior; and
a tube extends within the hollow interior to an exterior region of the scroll.

10. The assembly of claim 1, wherein the outer radial wall includes a flow diverter.

11. The assembly of claim 1, wherein each of the plurality of scroll stator vanes extend widthwise between the first axial sidewall and the second axial sidewall.

12. The assembly of claim 11, wherein each of the plurality of scroll stator vanes are connected to the first axial sidewall and the second axial sidewall.

13. The assembly of claim 1, wherein the outer radial wall of the flow channel is non-axisymmetric about the center axis.

14. The assembly of claim 13, wherein the outer radial wall spirals radially inwardly around a circumference of the scroll, and the flow channel portion has a cross-sectional area that decreases circumferentially.

15. The assembly of claim 1, wherein
the plurality of scroll stator vanes include a first scroll stator vane and a second scroll stator vane;
the first scroll stator vane is spaced from the outer radial wall by a first radial distance;
the second scroll stator vane is arranged within the flowpath downstream of the first scroll stator vane, and the second scroll stator vane is spaced from the outer radial wall by a second radial distance; and
the second radial distance is less than the first radial distance.

16. An assembly, comprising:
a turbine scroll comprising:
a flowpath extending between a scroll inlet and a scroll outlet;
an outer flow channel extending circumferentially about and radially along a center axis, the outer flow channel including an outer radial wall forming an outer peripheral boundary of the flowpath;
a plurality of scroll stator vanes distributed circumferentially about the center axis, the plurality of scroll stator vanes extending radially within the flowpath to the outer flow channel, the plurality of scroll stator vanes including a first scroll stator vane and a second scroll stator vane;
a vane passage extending axially between the first scroll stator vane and the second scroll stator vane, the vane passage extending radially between the outer flow channel and an annular collection region, and the vane passage configured to direct gas flow along the flowpath to the annular collection region; and
the annular collection region disposed radially inward of the plurality of scroll stator vanes, the annular collection region extending circumferentially about and axially along the center axis, and the annular collection region configured to receive gas flow from vane passage; and
a turbine stator vane assembly coupled with the scroll outlet, the turbine stator vane assembly including a plurality of turbine stator vanes distributed circumferentially about the center axis.

17. The assembly of claim 16, wherein
the first scroll stator vane includes a suction side surface and a pressure side surface;
the suction side surface extends between a leading edge and a trailing edge;
the pressure side surface includes a pressure side (PS) intervane passage portion and a trailing edge (TE) arc annular portion; and
the PS intervane passage portion extends between the leading edge and the TE arc annular portion, and the TE arc annular portion extends between the trailing edge and the PS intervane passage portion.

18. The assembly of claim 16, wherein
the turbine stator vane assembly includes a first turbine stator vane and a second turbine stator vane;
the first turbine stator vane includes a first angular orientation; and
the second turbine stator vane includes a second angular orientation, the second angular orientation different than the first angular orientation.

19. The assembly of claim 16, wherein
the turbine stator vane assembly includes a first circumferential section of turbine stator vanes and a second circumferential section of turbine stator vanes; and
the first circumferential section of turbine stator vanes includes an angular orientation different than the second circumferential section of turbine stator vanes.

20. An engine assembly, comprising:
a rotary engine including a plurality of rotary units in communication with one another, each rotary unit having an exhaust port;
an exhaust manifold connected to the exhaust port of each rotary unit, the exhaust manifold configured to receive a periodic flow of combustion gases from each exhaust port during operation of the engine;
a turbine scroll in fluid communication with the exhaust manifold and configured to receive the periodic flow of combustion gases, the turbine scroll comprising:
a flow channel defined by an outer radial wall extending between a first axial sidewall and a second axial sidewall, the first axial sidewall and second axial sidewall spaced widthwise apart from one another, the flow channel extending circumferentially around a center axis;
a scroll inlet configured to permit gas flow into the flow channel;
a plurality of scroll stator vanes disposed within the flow channel, spaced apart from one another and disposed around a circumference of the scroll; and
a plurality of vane passages, each vane passage defined between adjacent said scroll stator vanes of the plurality of scroll stator vanes, each vane passage is open to an outer flow channel portion of the flow channel disposed radially between the scroll stator vanes and the outer radial wall and is open to an annular region disposed radially inside of the plurality of scroll stator vanes, the vane passages configured to direct gas flow in an inwardly spiraling direction having a radially inward component and a circumferential component;
the annular region disposed radially inboard of the plurality of scroll stator vanes and configured to receive gas flow from the plurality of vane passages; and
an axial turbine configured to receive gas flow from the turbine scroll.
